(19) United States
(12) Patent Application Publication
(10) Pub. No.: US 2012/0255753 A1
(43) Pub. Date: Oct. 11, 2012

(54) HAND-POWER TOOL WITH AN OSCILLATION-DAMPING DEVICE

(75) Inventors: Alex Kuhnle, Freiberg A. N. (DE); Matthias Tauber, Bad Boll (DE); Juergen Bochert, Stuttgart (DE); Carsten Diem, Ludwigsburg (DE); Willy Braun, Neustetten (DE); Christian Wiedemann, Wiernsheim (DE); Joerg Kaiser, Schwieberdingen (DE); Patrick Heinen, Ludwigsburg (DE); Roger Hahn, Neuhausen (DE); Thomas Speda, Holzgerlingen (DE)

(73) Assignee: Robert Bosch GmbH, Stuttgart (DE)

(21) Appl. No.: 13/515,652

(22) PCT Filed: Oct. 22, 2010
(86) PCT No.: PCT/EP10/65967

§ 371 Date: Jun. 13, 2012

(30) Foreign Application Priority Data
Dec. 16, 2009 (DE) 10 2009 054 731.2

(51) Int. Cl. B25D 17/24

(52) U.S. Cl. 173/162.2

(57) ABSTRACT

A hand-power tool includes at least one oscillation-damping device that has at least one damping spring, a damping mass, and a mechanism housing. The oscillation-damping device has at least two retaining parts that at least partly enclose the damping mass.

### PRIOR ART

The invention proceeds from a portable power tool as per the preamble of claim 1.

A portable power tool having at least one vibration absorbing device which has at least an absorption spring, an absorption mass and a mechanism housing is already known from EP 1 736 283 A2.

### SUMMARY OF THE INVENTION

The invention proceeds from a portable power tool having at least one vibration absorbing device which has at least an absorption spring, an absorption mass and a mechanism housing.

It is proposed that the vibration absorbing device has at least two holding parts which at least partially enclose the absorption mass. In particular, a “portable power tool” should be understood as meaning all portable power tools that appear to be practical to a person skilled in the art, such as, in particular, percussion drilling machines, jackhammers, rotary hammers, percussion hammers, percussion drill/drivers and/or advantageously rotary and/or demolition hammers. A “vibration absorbing device” should be understood as meaning in particular a device which, in at least one operating state, produces a force on a portable power tool housing and/or a mechanism housing and in particular on at least one handle of the portable power tool, said force counteracting a vibration in particular of the portable power tool housing. In this way, the vibration absorbing device allows advantageously low-vibration operation of the portable power tool. Preferably, the vibration absorbing device works passively, that is to say without supplying energy apart from the vibration energy. In particular, the term “absorption spring” should be understood as meaning a spring which is provided to transmit a force, in particular directly, to the absorption mass, said force accelerating and/or decelerating the absorption mass. Advantageously, the absorption spring is formed as a helical compression spring. Alternatively or in addition, the absorption spring could have a rectangular cross section perpendicularly to a spring direction or a plurality of absorption springs could be arranged in a nested and/or coaxial manner. Likewise alternatively or in addition, the absorption spring could be formed as some other torsion spring, flexible spring, tension spring and/or gas spring which appears to be practical to a person skilled in the art. A “spring direction” should be understood as meaning in particular at least a direction in which the absorption spring has to be loaded in order to be able to elastically store the most energy. Advantageously, the absorption spring is formed to be elastically deformable in the spring direction by at least 25% of a length in the unloaded state. An “absorption mass” should be understood as meaning in particular a unit which is provided to reduce the vibration in particular of the portable power tool housing by inertia by means of an acceleration force and/or a deceleration force, advantageously in that said unit vibrates in a manner shifted through a phase angle with respect to the portable power tool housing. The term “provided” should be understood as meaning in particular specially equipped and/or designed. A “holding part” should be understood as meaning in particular an element of the vibration absorbing device which is connected to the housing cover such that it cannot move in relation to the housing cover in a fitted operating state. Preferably, the holding part has a fastening means which fastens the vibration absorbing device and in particular the absorption spring directly to the mechanism housing. Preferably, the holding part and the absorption spring are connected directly together. In particular, the holding part is a component formed separately from the mechanism housing and advantageously from a housing cover. Advantageously, the holding part additionally exerts a force on at least one element of a drive mechanism in a fitted operating state. A “fastening means” should be understood as meaning in particular a means which is provided to bring about a force on the vibration absorbing device, said force fastening at least one element of the vibration absorbing device, preferably the holding part, such that it cannot move in relation to the fitted housing cover. Advantageously, the fastening means is formed at least partially in one piece with the housing cover. The fastening means is formed as a groove, as part of a screw connection, as part of a latching connection and/or as part of some other connection that appears to be practical to a person skilled in the art. A “mechanism housing” should be understood as meaning in particular a housing in which at least the drive mechanism is arranged in a protected manner. Advantageously, the mechanism housing is formed at least partially in one piece with the portable power tool housing. Advantageously, the mechanism housing is provided to dissipate bearing forces, at least of the drive mechanism. The term “enclose” should be understood as meaning in particular that the holding parts surround at least one point of the absorption mass on a plane with is oriented preferably perpendicularly to the spring direction, by at least 180 degrees, advantageously at least 270 degrees, particularly advantageously 360 degrees. By way of the embodiment according to the invention, a particularly robust, compact and cost-effective portable power tool, which allows particularly low-vibration operation, can be provided in a structurally simple manner. In particular, small guide forces and a low degree of friction, and thus a low degree of wear, can be achieved as a result.

It is further proposed that at least the absorption spring brings about a fastening force on the mechanism housing and in particular on a housing cover of the mechanism housing in at least one operating state, as a result of which assembly with a particularly low amount of effort can be achieved. In particular, the expression “bring about a fastening force” should be understood as meaning that the absorption spring exerts on the mechanism housing the fastening force which counteracts and advantageously prevents a movement at least of a part of the vibration absorbing device in relation to the mechanism housing, in particular a movement of the holding parts. In particular, the fastening force pushes the holding parts away from one another.

In addition, it is proposed that the holding parts are formed as identical parts, as a result of which design outlay can advantageously be saved. “Identical parts” should be understood as meaning in particular components which have identical external dimensions. Preferably, the identical parts are formed in a mirror-inverted manner with respect to one another. Alternatively, the identical parts could have an identical external appearance.

Furthermore, it is proposed that the holding parts are provided to guide the absorption spring, as a result of which particularly reliable operation and high ease of maintenance can be achieved. In this connection, “guide” should be understood as meaning in particular that the holding parts are provided to exert a bearing force perpendicularly to the spring direction on the absorption spring. Preferably, the force prevents a substantial movement, deviating from the spring direction, of the absorption spring.

In an advantageous embodiment of the invention, it is proposed that the vibration absorbing device has at least one spring receptacle which is connected in a form-fitting manner to the absorption mass, as a result of which a particularly inexpensive, easy to maintain and space-saving connection is possible in a structurally simple manner. A “spring receptacle” should be understood as meaning in particular an element of the vibration absorbing device which is arranged in a flux of force between the absorption spring and absorption mass. Advantageously, the spring receptacle is connected in a mechanically fixed manner to the absorption mass. Preferably, the spring receptacle is movable in relation to the mechanism housing. A “form fit” should be understood as meaning in particular a connection which transmits a force in a force direction over at least one surface, said force having an average extent substantially perpendicular to the force direction. In this case, a spatial configuration of the spring receptacle and of the absorption mass advantageously prevents a movement of the spring receptacle in relation to the absorption mass. Alternatively or in addition, the spring receptacle and the absorption mass could be connected together in a force-fitting, friction-fitting or materially integral manner.

In a further embodiment, it is proposed that the portable power tool has a mechanism housing having a housing cover which has a fastening means which at least partially fastens the vibration absorbing device in at least one operating state. A “housing cover” should be understood as meaning in particular an element of the mechanism housing which is formed to be separable from another element of the mechanism housing, in particular a housing shell, without being damaged. Advantageously, the vibration absorbing device and the drive mechanism are arranged in a chamber which is closed by the housing cover. In other words, the vibration absorbing device is arranged on an inner side of the housing cover. As a result, it is protected particularly advantageously from external influences such as dirt and mechanical damage in a structurally simple manner. Advantageously the chamber is formed as a grease chamber of the portable power tool. Advantageously, the housing cover is provided to close an opening, which is provided in particular for fitting the drive mechanism, in the other element of the mechanism housing. Advantageously, the housing cover is free of bearing forces of the drive mechanism. Particularly advantageously, the housing cover transmits primarily forces of the vibration absorbing device and in particular forces which act externally on the bearing cover. In particular, a “drive mechanism” should be understood as meaning a mechanism which converts a movement of a drive motor into a working movement, in particular a percussion movement. In particular the term “close” should be understood as meaning that the housing cover covers an opening in the other element of the mechanism housing, in particular the housing shell, in an operationally ready state. As a result, the housing cover protects the chamber from contamination, that is to say that it prevents dirt and in particular dust from penetrating through the opening to the drive mechanism.

Furthermore, it is proposed that the vibration absorbing device has at least one spring receptacle which exerts an acceleration force on the absorption mass in at least one operating state and supports an opposing force to the acceleration force on the holding part in at least one operating state, as a result of which a particularly small installation space requirement and low costs can be achieved. Advantageously, the spring receptacle exerts the acceleration force at one point in time and supports the opposing force at another point in time. In particular an “acceleration force” should be understood as meaning a force which accelerates and/or decelerates the absorption mass. An “opposing force” should be understood as meaning in particular a force which supports the absorption spring on one side when on the other side of the absorption spring the acceleration force acts on the absorption mass.

In a further embodiment, it is proposed that the vibration absorbing device has at least one support element which presses the spring receptacle against the absorption spring in at least one operating state, as a result of which particularly low design outlay, an advantageous spring characteristic of the vibration absorbing device and advantageous compensation of tolerances can be achieved. In particular, it is possible to dispense with a form-fitting, materially integral and/or frictional connection between the spring receptacle and the absorption mass. A “support element” should be understood as meaning in particular an element which brings about a force on the spring receptacle in at least one operating state, said force counteracting a force which the absorption spring brings about on the spring receptacle. Advantageously, the support element is formed as a cylindrical compression spring, as an elastomeric part, as a wave spring or disk spring and/or as some other element that appears to be practical to a person skilled in the art. Preferably, the force of the support element on the spring receptacle in at least one operating state is, advantageously always, much smaller than a force of the absorption spring on the same spring receptacle. “Much smaller” should be understood in this context as meaning in particular less than 50%, advantageously less than 25%, particularly advantageously less than 10%, of the force of the absorption spring. Alternatively, it would also be possible to dispense with support elements in the vibration absorbing device.

Furthermore, it is proposed that the absorption spring is arranged entirely in an axial region of the absorption mass, as a result of which an advantageously small overall length in the spring direction can be achieved. An “axial region of the absorption mass” should be understood as meaning in particular a region which is bounded by two planes, which are oriented perpendicularly to the spring direction and intersect the absorption mass.

Furthermore, it is proposed that the housing cover and the vibration absorbing device form a preassemblable subassembly, as a result of which an advantageously low amount of assembly effort can be achieved. The expression “form a preassemblable subassembly” should be understood as meaning in particular that, during fitting, in particular before the housing cover is fastened to the mechanism housing, the housing cover and the vibration absorbing device can be connected fixedly together. As a result, the housing cover and the vibration absorbing device can be connected to form a fittable unit. Advantageously, the housing cover and the vibration absorbing device can be connected together such that they can be fitted jointly. Particularly advantageously, the housing cover and the vibration absorbing device can be connected together such that they can transmit the acceleration force and/or an opposing force to the acceleration force.

### DRAWING

Further advantages can be gathered from the following description of the drawing. The drawing illustrates two exemplary embodiments of the invention. The drawing, the description and the claims contain numerous features in combination. A person skilled in the art will expediently view the features individually and combine them to form practical further combinations.

In the drawing:

FIG. 1 shows a portable power tool according to the invention, having a vibration absorbing device which is fastened to a housing cover,

FIG. 2 shows a section through the portable power tool from FIG. 1,

FIG. 3 shows a housing cover and the vibration absorbing device of the portable power tool from FIG. 1,

FIG. 4 shows a section (A-A) through the housing cover and the vibration absorbing device,

FIG. 5 shows a plan view of a partial section through the vibration absorbing device of the portable power tool from FIG. 1,

FIG. 6 shows a front view of a section (B-B) through the vibration absorbing device of the portable power tool from FIG. 1,

FIG. 7 shows a side view of the vibration absorbing device of the portable power tool from FIG. 1,

FIG. 8 shows a partial section through an alternative exemplary embodiment of the vibration absorbing device from FIG. 1 with a spring receptacle which is movable in relation to the absorption mass, and

FIG. 9 shows a front view of a section (C-C) through the vibration absorbing device from FIG. 8.

### DESCRIPTION OF THE EXEMPLARY EMBODIMENTS

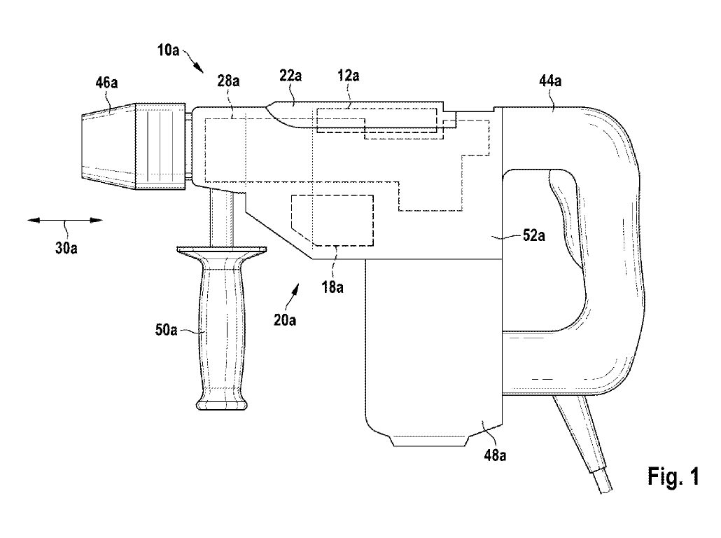

FIG. 1 shows a portable power tool 10a according to the invention having a vibration absorbing device 12a, a drive mechanism 18a and having a mechanism housing 20a which has a metal housing cover 22a. The portable power tool 10a is formed as a rotary and demolition hammer. The mechanism housing 20a encloses a chamber 24a in which the drive mechanism 18a and the vibration absorbing device 12a are arranged. Furthermore, the portable power tool 10a has a main handle 44a, an application tool fastening 46a, a motor housing 48a and an auxiliary handle 50a. The main handle 44a is connected to the mechanism housing 20a and the motor housing 48a on a side of the mechanism housing 20a that is remote from the application tool fastening 46a. The auxiliary handle 50a is connected to the mechanism housing 20a on a side facing the application tool fastening 46a.

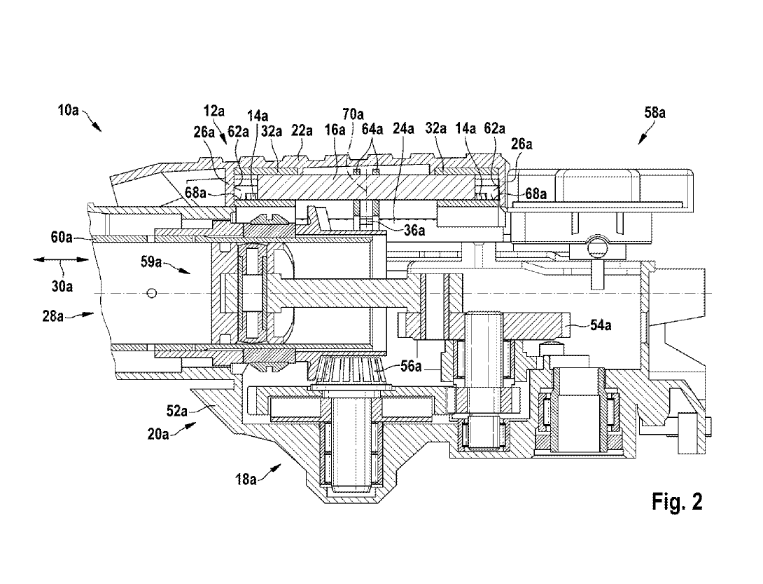

FIG. 2 shows a section through the mechanism housing 20a, which has a housing shell 52a in addition to the housing cover 22a. Arranged in the chamber 24a are the vibration absorbing device 12a and the drive mechanism 18a. The drive mechanism 18a has a percussion mechanism 28a, a first and a second transmission element 54a, 56a for drilling operation and a switching mechanism 58a. The percussion mechanism 28a is formed as a hammer percussion mechanism. The first transmission element 54a is formed additionally as an eccentric element of the percussion mechanism 28a. Furthermore, the percussion mechanism 28a has a piston 59a, a hammer tube 60a and, not illustrated in more detail, a striker and an anvil. The second transmission element 56a drives the hammer tube 60a in rotation. The rotational movement of the hammer tube 60a can be switched off by the switching mechanism 58a in a manner that appears to be practical to a person skilled in the art.

The housing cover 22a of the mechanism housing 20a is arranged on a side of the housing shell 52a that is opposite the motor housing 48a. It closes a fitting opening located there, and thus the chamber 24a. The portable power tool 10a has a seal (not illustrated in more detail), which is arranged between the housing cover 22a and the housing shell 52a. As a result, the vibration absorbing device 12a and the drive mechanism 18a are protected from contamination. The chamber 24a is formed as a grease chamber, that is to say that joint, permanent lubrication is ensured in the chamber 24a. The vibration absorbing device 12a and the drive mechanism 18a are arranged in the chamber 24a, which is closed by the housing cover 22a.

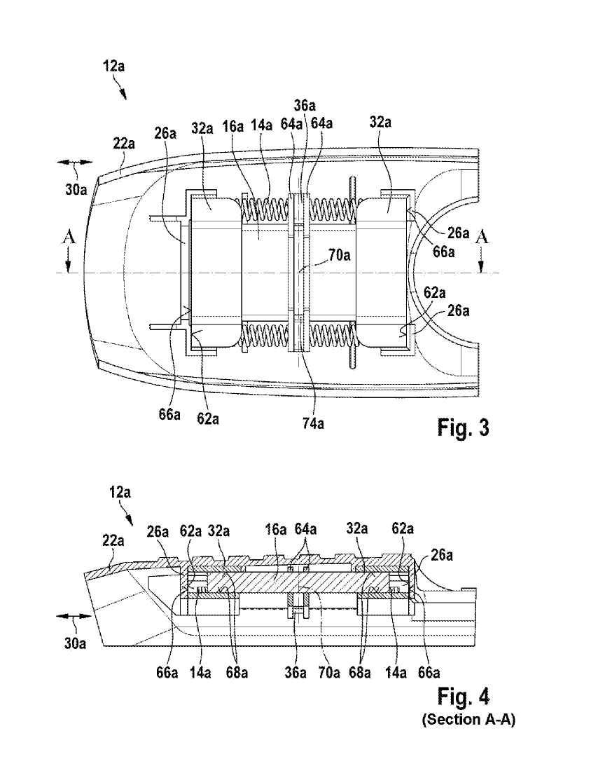

As is shown in FIGS. 3 to 7, the housing cover 22a has three fastening means 26a. The fastening means 26a are formed as integrally formed webs. The fastening means 26a have fastening surfaces 62a oriented perpendicularly to a spring direction 30a. The fastening means 26a fasten the vibration absorbing device 12a in the spring direction after the fitting of the subassembly, that is to say after the vibration absorbing device 12a has been inserted into the cover, and during operation. To this end, during fitting, the vibration absorbing device 12a is compressed in the spring direction 30a and inserted into the housing cover 22a. As a result, absorption springs 14a of the vibration absorbing device 12a bring about a fastening force on the housing cover 22a by prestressing in the spring direction 30a after the fitting of the subassembly and during operation. The fastening force fastens the vibration absorbing device 12a to the housing cover 22a in a force-fitting manner perpendicularly to the spring direction 30a. Thus, the vibration absorbing device 12a and the housing cover 22a form a preassemblable subassembly, that is to say that the vibration absorbing device 12a and the housing cover 22a form together, and separately from the housing shell 52a, an inherently stable unit.

Following fitting of the housing cover 22a on the housing shell 52a, the housing shell 52a brings about a fastening force on the vibration absorbing device 12a in a region which is not illustrated in more detail. The fastening force acts perpendicularly to the spring direction 30a. Alternatively or in addition, the vibration absorbing device 12a could be latched, screwed, adhesively bonded and/or connected to the housing cover 22a in some other way that appears to be practical to a person skilled in the art.

The percussion mechanism 28a and the vibration absorbing device 12a are arranged partially on identical planes, which are oriented perpendicularly to a spring direction 30a, that is to say that the percussion mechanism 28a and the vibration absorbing device 12a are arranged partially adjacent to one another. A region of the vibration absorbing device 12a that faces the application tool fastening 46a is arranged between the housing cover 22a and the percussion mechanism 28a. This region is free of functional components apart from the vibration absorbing device 12a.

The vibration absorbing device 12a is formed in a mirror-symmetrical manner in a rest state. It has four absorption springs 14a, an absorption mass 16a, two holding parts 32a, two spring receptacles 36a and two spring receptacle fastenings 64a. The two holding parts 32a are formed as identical parts, that is to say that they have an identical but mirror-inverted form with respect to one another. In addition, the holding parts 32a have a slight oversize with respect to the housing cover 22a. Outer sides 66a of the holding parts 32a, which face or are remote from the application tool fastening, fasten the vibration absorbing device 12a in the housing cover 22a. The absorption springs 14a, the absorption mass 16a, the two spring receptacles 36a and the two spring receptacle fastenings 64a are arranged between the holding parts 32a. The spring receptacles 36a and the spring receptacle fastenings 64a are produced at least partially from plastics material.

The holding parts 32a have guide surfaces 68a, which guide the absorption mass 16a in the spring direction 30a during operation. For this purpose, the holding parts 32a enclose the absorption mass 16a on a plane which is formed perpendicularly to the spring direction 30a. In this exemplary embodiment, the holding parts 32a enclose the absorption mass 16a entirely.

Alternatively, the holding parts 32a could enclose the absorption mass 16a by more than 180 degrees. The holding parts 32a guide the absorption mass 16a on surfaces which are arranged furthest away from the center of gravity 70a of the absorption mass 16a, as a result of which small guide forces and a low degree of friction can be achieved. Alternatively or in addition, a housing cover could also guide the absorption mass 16a and/or the absorption spring 14a. Furthermore, the holding parts 32a each have spring fastenings 72a, which fasten the absorption springs 14a. For this purpose, the absorption springs 14a are screwed onto the spring fastenings 72a.

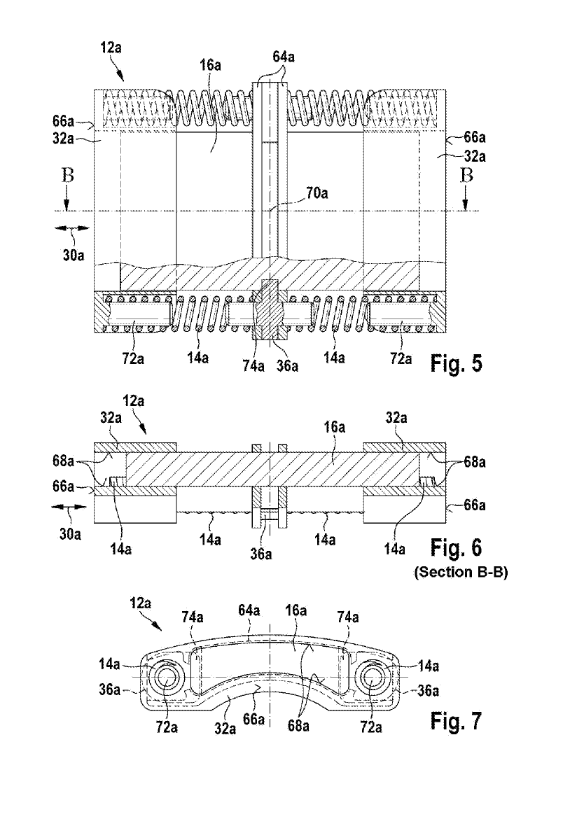

The four absorption springs 14a are each connected in a mechanically fixed manner on one side to the holding parts 32a and on one side to the spring receptacles 36a. The spring receptacles 36a have a cruciform cross section as seen perpendicularly to the spring direction 30a (FIG. 5). On a side facing the center of gravity 70a of the absorption mass 16a, the spring receptacles 36a extend into recesses 74a in the absorption mass 16a. In this case, the spring receptacles 36a are supported on the absorption mass 16a. During fitting, the spring receptacle fastenings 64a are pushed onto the absorption mass 16a and fix the spring receptacles 36a such that a form-fitting connection is established between the spring receptacles 36a and the absorption mass 16a. The spring forces of the absorption springs 14a fasten the spring receptacle fastening 64a.

In addition, the vibration absorbing device could have damping elements (not illustrated in more detail), which damp a striking of the absorption mass 16a against an end stop. For example, the damping elements could be arranged between the spring receptacles 36a and the holding parts 32a inside the absorption springs 14a in a guide for the holding parts 32a or on the housing cover 22a.

The absorption mass 16a has a uniform cross section in the spring direction 30a. The cross section is formed by means of an extrusion process. Absorption masses are cut down from a bar by a machine and in the same work step are provided with recesses for accommodating spring receptacles. Alternatively or in addition, an absorption mass could have a plurality of mass parts. Advantageously, at least one of the mass parts likewise has a uniform cross section. Particularly advantageously, at least one of the mass parts has a preferably largely standardized cross section in at least one direction.

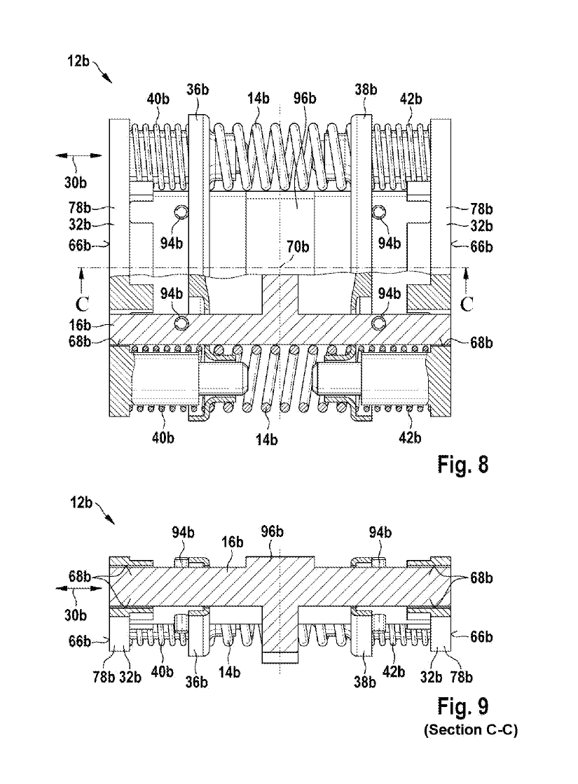

FIGS. 8 and 9 show a further exemplary embodiment of the invention. In order to differentiate the exemplary embodiments, the letter a in the reference signs of the exemplary embodiment in FIGS. 1 to 7 has been replaced by the letter b in the reference signs of the exemplary embodiment in FIGS. 8 and 9. The following descriptions are limited substantially to the differences between the exemplary embodiments, it being possible to refer to the description of the other exemplary embodiments, in particular in FIGS. 1 to 7, with regard to components, features and functions which remain the same.

The exemplary embodiment in FIGS. 8 and 9 relates, as described in the exemplary embodiment of FIGS. 1 to 7, to a portable power tool 10b according to the invention having a vibration absorbing device 12b illustrated in FIGS. 8 and 9, a drive mechanism 18b and a mechanism housing 20b having a housing cover 22b and a housing shell 52b. In an operationally ready state, the housing cover 22b closes a chamber 24b in which the drive mechanism 18b is arranged. The housing cover 22b has fastening means 26b, which fasten the vibration absorbing device 12b in the operationally ready state.

The vibration absorbing device 12b has two absorption springs 14b, an absorption mass 16b, a first and a second holding part 32b, a first and a second spring receptacle 36b, 38b, and four support elements 40b, 42b. The holding parts 32b are pushed onto the absorption mass 16b. There, the holding parts 32b are secured by way of immobilizing elements 94b. The immobilizing elements 94b are formed as clamping sleeves, but could also be formed as other units that appear to be practical to a person skilled in the art. The holding parts 32b are mounted in a movable manner in the spring direction 30b on the absorption mass 16b, specifically between in each case two immobilizing elements 94b and a central shoulder 96b. The central shoulder 96b extends perpendicularly to the spring direction 30b.

The first holding part 32b and the first spring receptacle 36b are arranged facing the application tool fastening 46b. In an operating state, the absorption mass 16b moves the second spring receptacle 38b in the direction of the application tool fastening 46b. In the process, the second spring receptacle 38b exerts an acceleration force on the absorption mass 16b. The acceleration force brakes the absorption mass 16b. The second spring receptacle 38b in the process transmits movement energy of the absorption mass 16b via the immobilizing elements 94b to the absorption springs 14b. The absorption springs 14b buffer store this energy. After the absorption springs 14b have stopped the absorption mass 16b in relation to the holding parts 32b, the absorption springs 14b return the energy to the absorption mass 16b and thus accelerate the absorption mass 16b. During this movement of the absorption mass 16b from a central position in the direction of the application tool fastening 46b, the first spring receptacle 36b supports an opposing force to the acceleration force on the first holding part 32b. Once the absorption mass 16b has crossed a central position, the same process occurs in a mirror-inverted manner in the opposite direction.

The support elements 40b, 42b press the spring receptacles 36b, 38b against the absorption springs 14b in two different operating states. A force of the support elements 40b, 42b is in this case much smaller than the acceleration force of the absorption springs 14b. The support elements 40b, 42b are in this case oriented coaxially with the absorption springs 14b. The absorption springs 14b are arranged entirely in an axial region, that is to say laterally next to the absorption mass 16b.

1. A portable power tool, comprising:
at least one vibration absorbing device which has at least an absorption spring,
an absorption mass, and
a mechanism housing,
wherein the at least one vibration absorbing device has at least two holding parts which at least partially enclose the absorption mass.

2. The portable power tool as claimed in claim 1, wherein the absorption spring brings about a fastening force on the mechanism housing in at least one operating state.

3. The portable power tool as claimed in claim 1, wherein the holding parts are formed as identical parts.

4. The portable power tool as claimed in claim 1, wherein the holding parts are configured to guide the absorption spring.

5. The portable power tool as claimed in claim 1, wherein the vibration absorbing device has at least one spring receptacle which is connected in a form-fitting manner to the absorption mass.

6. The portable power tool as claimed in claim 1, wherein the mechanism housing has a housing cover which has a fastening mechanism configured to at least partially fasten the vibration absorbing device in at least one operating state.

7. The portable power tool as claimed in claim 1, wherein the vibration absorbing device has at least one spring receptacle which exerts an acceleration force on the absorption mass in at least one operating state and supports a force on the holding part in at least one operating state.

8. The portable power tool as claimed in claim 7, wherein the vibration absorbing device has at least one support element configured to press the spring receptacle against the absorption spring.

9. The portable power tool as claimed in claim 1, wherein the absorption spring is arranged entirely in an axial region of the absorption mass.

10. A vibration absorbing system for a portable power tool, comprising:
at least one vibration absorbing device which has at least an absorption spring,
an absorption mass, and
a mechanism housing,
wherein the at least one vibration absorbing device has at least two holding parts which at least partially enclose the absorption mass.
